(19) United States
(12) Patent Application Publication
(10) Pub. No.: US 2025/0130608 A1
(43) Pub. Date: Apr. 24, 2025

(54) DAMPER FOR A PEDAL OF A VEHICLE, PEDAL HAVING A DAMPER OF THIS TYPE, AND SYSTEM

(71) Applicant: HELLA GmbH & Co. KGaA, Lippstadt (DE)

(72) Inventor: Robert SCHUERMANN, Herzebrock-Clarholz (DE)

(73) Assignee: HELLA GmbH & Co. KGaA, Lippstadt (DE)

(21) Appl. No.: 18/920,845

(22) Filed: Oct. 18, 2024

(30) Foreign Application Priority Data
Oct. 19, 2023 (DE) 102023128771.0
Nov. 30, 2023 (DE) 102023133596.0

(51) Int. Cl. G05G 5/05; B60K 26/02; B60T 7/06; F16F 13/00; G05G 1/44; G05G 5/04

(52) U.S. Cl. CPC G05G 5/05; F16F 13/007; G05G 1/44; G05G 5/04; B60K 26/02; B60T 7/06; G05G 2505/00

(57) ABSTRACT

A damper for a pedal of a vehicle, comprising a hollow body for receiving a medium and a valve. The body is compressible or expandable from an idle position. The valve is designed to allow the medium to flow into and/or out of the body. The inflow and/or the outflow of the medium being controlled by the valve such that during the compression of the body from the idle position, the outflow of the medium takes place rapidly and, upon the return to the idle position, the inflow of the medium takes place slowly or such that during the expansion of the body from the idle position, the inflow of the medium takes place rapidly and, upon the return to the idle position, the outflow of the medium takes place slowly. A pedal and system are also provided.

This nonprovisional application claims priority under 35 U.S.C. § 119(a) to German Patent Application No. 10 2023 128 771.0, which was filed in Germany on Oct. 19, 2023, and to German Patent Application No. 10 2023 133 596.0, which was filed in Germany on Nov. 30, 2023, which are both herein incorporated by reference.

### BACKGROUND OF THE INVENTION

### Field of the Invention

The present invention relates to a damper for a pedal of a vehicle, comprising a hollow body for receiving a medium and comprising a valve, the body being compressible or expandable from an idle position.

### Description of the Background Art

In modern vehicles, the coupling between pedals, for example, the brake pedal and/or gas pedal, and vehicle components to be actuated is increasingly omitted. A pedal usually comprises at least a housing and an operating part, which is actuated, preferably stepped on, by a driver of the vehicle. If the operating part of a pedal, for example a brake pedal, is actuated, measures are known to those skilled in the art to emulate the familiar haptic feedback during the actuation of the operating part. For example, the normal feel of a brake pedal may be generated by the interplay between different springs. The position of the operating part of the pedal is sensed by sensors, and the electronic values are transmitted to a controller and/or regulator. Actuator motors are driven as a function of these sensor signals to actuate, for example, the brake.

The actuating forces during a strong braking, for example a full braking, may be several hundred newtons. Strong springs are therefore used to emulate the haptic feedback of a pedal, in particular a brake pedal.

The springs build up a restoring force by the actuation of the operating part, which returns the operating part to its initial position when it is released again.

The disadvantage here is that, strong springs, in particular, like those required in a brake pedal, build up a very strong restoring force, which allows the operating part to spring back into the initial position very fast after its release. This springing back of the operating part may result in noise at an end stop, in particular, upon reaching the initial position. This may be induced, for example, by a striking of the operating part against the housing.

This noise is highly undesirable. Hydraulic approaches are known for suppressing the noise development. They have a complicated structure and are therefore susceptible to faults and are expensive.

This point is where the invention comes in.

### SUMMARY OF THE INVENTION

It is therefore an object of the present invention is to propose a damper for a pedal of a vehicle, which suppresses a noise development upon the springing back of an operating part of a pedal into an initial position, and which is cost-effective and designed to be less susceptible to faults.

The object is achieved according to an example of the invention by a damper for a pedal of a vehicle, comprising a hollow body for receiving a medium, and a valve, the body being compressible or expandable from an idle position, the valve being suitable and designed to allow the medium to flow into and/or flow out of the body, the inflow and/or outflow of the medium being controlled by the valve in such a way that, when the body is compressed from the idle position, the outflow of the medium takes place rapidly and, when it returns to the idle position, the inflow of the medium takes place slowly, or, when the body expands from the idle position, the inflow of the medium takes place rapidly, and when it returns to the idle position, the outflow of the medium takes place slowly.

The particular advantage of the proposed damper is that the return of the body from a compression and/or expansion may be controlled by the valve. The amount of time required to return from a compression and/or expansion into the idle position of the body may thus be set according to different needs. If the body of the damper is compressed from the idle position, it is necessary for this compression to take place rapidly and for the compression of the body to be hindered as little as possible. The outflow of the medium therefore takes place rapidly. The same applies if the body is expanded from an idle position. The expansion should take place rapidly and be hindered as little as possible. In this case, the inflow of the medium takes place rapidly. If the compression or expansion is released, the damping properties of the damper become especially apparent. The valve is therefore designed in such a way that, upon the return to the idle position from the compression, the inflow of the medium takes place slowly, or upon the return to the idle position from the expansion, the outflow of the medium takes place slowly. The medium used is preferably air, since it is available all around the damper without any special precautions. However, other types of media may be used as needed without changing the inventive idea.

It may be provided that the damper comprises a spring, the spring being arranged in the interior of the body, the ends of the spring at least indirectly resting against an outer shell of the body at least indirectly in the interior of the body. It is advantageous if the damper also comprises a spring in addition to the body, since the spring may return the body of the damper to the idle position in a supporting manner.

It may be provided that the return to the idle position influenced by the valve differs from the return to the idle position which is influenced by the spring and/or the body.

The spring can also be compressed during a compression of the body and also stretched during an expansion of the body. The spring at least indirectly rests against the outer shell of the body in the interior thereof with the ends of the spring and is connected to the body in such a way that the spring undergoes the same deformation during a compression or expansion of the body.

It is therefore possible that the body and/or the spring have/has a compression stress during the compression of the body, and the body and/or the spring have/has a tensile stress during the expansion of the body, the compression stress counteracting the compression or the tensile stress counteracting the expansion of the body.

The built-up compression stress and tensile stress result in that the body is returned to the idle position when the compression and expansion are released. However, the proposed valve makes it possible to control the amount of time in which the return takes place. Without the valve, the return to the idle position would be influenced by the spring and the body. A stronger spring or a stronger deflection of the spring would unavoidably result in a faster return to the idle position. This is not desirable. The return of the body to the idle position is controlled with the aid of the valve in such a way that the body enters the idle position gently and without generating a striking noise.

To facilitate a compression and/or expansion, it may be provided that the body is at least partially made from an elastomer. A body which is at least partially made from an elastomer is elastically deformable, so that the body regains its original shape when a force is no longer acting upon the body. The body could be at least partially made from, for example, a silicon or ethylene propylene diene monomer rubber. It should be assumed within the scope of this application that the body is designed in such a way that the deformation does not go beyond the elastic range. The spring may also be deformed in an elastic range, so that the body as well as the spring strive to return to an idle position when a force no longer acts thereupon. The special feature of the damper according to the invention is the speed, influenced by the valve, at which the body returns to the idle position.

It may furthermore be provided that the body comprises multiple parts. This is advantageous, in particular, to place the spring in the interior of the body and to have it at least indirectly rest against the inside of the outer shell with the ends of the spring. Due to a multi-part body, this is possible in simple work steps.

It may be provided that the spring has a linear or a progressive or a digressive spring characteristic curve. In particular, a steel spring having an anti-corrosion coating may be used.

The pedal for a vehicle comprises at least a housing and an operating part and a damper according to the invention, the damper being arranged between the housing and the operating part. The advantage of this pedal is that an actuation of the pedal is also possible in the case of a fault in the damper.

It may be provided that the operating part is movably arranged with respect to the housing, the operating part being able to be brought into a working position from an initial position by an external application of force. The external application of force may be undertaken by a driver of the vehicle, who presses the operating part of the brake pedal or the gas pedal to actuate the brake or to accelerate.

It may be provided that a movement of the operating part relative to the housing induces a compression or expansion of the body. Since the damper is arranged between the housing and operating part, a movement of the operating part relative to the housing results in a compression or expansion of the body of the damper. It depends on how the damper is arranged between the housing and the operating part. It is conceivable that a movement of the operating part compresses the body of the damper when the space available between the housing and the operating part decreases at the location of the damper. It is likewise conceivable that the movement of the operating part results in an expansion of the body when the space available between the housing and the operating part increases at the location of the damper.

It may be provided, for example, that the damper is designed to move the operating part from the working position into the initial position. If the external application of force to the operating part is released, for example because the driver of the vehicle takes his/her foot off the operating part of the pedal, the damper is designed to return the operating part to its initial position. The damper and the operating part are connected in such a way that the effect of the valve influencing the return of the body into the idle position is transferred to the operating part of the pedal and returns it to its initial position at the same speed at which the body takes up its idle position.

It may be provided that the operating part rests against an end stop upon reaching the initial position.

It may likewise be provided that the damper is arranged between the housing and the operating part in such a way that the operating part is in its initial position when the damper reaches the idle position.

The system comprises a pedal according to the invention and a vehicle.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an exploded drawing of a damper according to an example of the invention;

FIG. 2 shows a sectional view of the damper in FIG. 1;

FIG. 3 shows a schematic representation of a pedal according to an example of the invention;

FIG. 4 shows a schematic representation of a pedal according to an example of the invention;

FIG. 5 shows a side view with a partial sectional view of a pedal according to an example of the invention in an initial position; and

FIG. 6 shows a side view with a partial sectional view of a pedal according to FIG. 5 in a working position.

### DETAILED DESCRIPTION

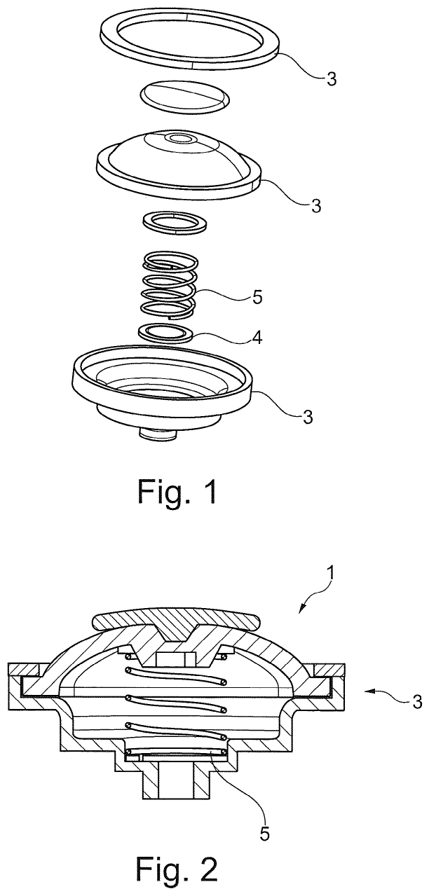

FIG. 1 shows an exploded drawing of a damper according to an example of the invention. The damper is illustrated in FIG. 2 in an assembled state in a sectional view. The damper comprises a hollow body for receiving a medium, a spring, and a valve. In the example, the body is provided with a multi-part design, so that the spring may be particularly easily introduced into the interior of the hollow body. The multi-part body comprises a closing ring for the purpose of closing the multi-part body. The ends of the spring indirectly rests against an outer shell of the body via a carrier in the interior of the body, as is apparent, in particular, in FIG. 2.

The hollow body is suitable for receiving a medium, which may flow into and/or flow out of the body via the valve. The medium may be, for example, air. Due to the selected design, the hollow body is, at least to a great extent, tight against its surroundings, so that the medium may flow in and/or flow out via the valve.

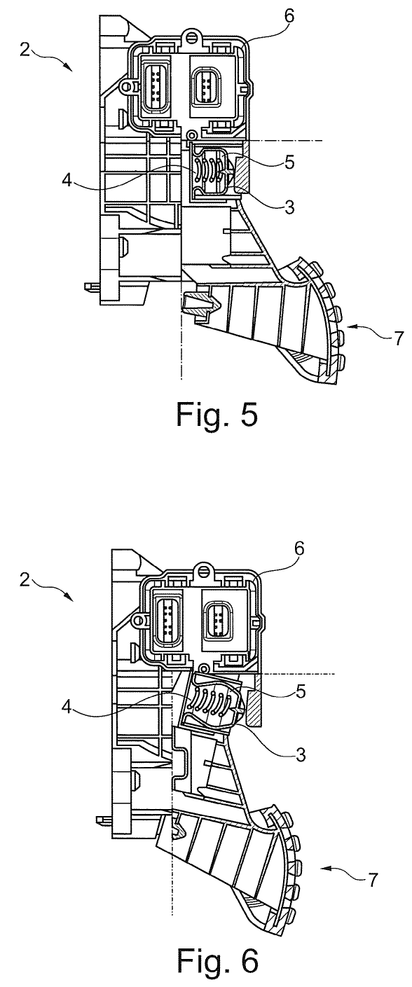

The body is at least partially made from an elastomer. The body is therefore compressible or expandable from an idle position. Since the spring at least indirectly rests against the outer shell of the body in the interior thereof, the compression or expansion is transferred to the spring. This is particularly apparent in FIGS. 5 and 6.

The body and the spring have a compression stress during the compression of the body, and the body and the spring have a tensile stress during the expansion of the body, the compression stress counteracting the compression or the tensile stress counteracting the expansion of the body.

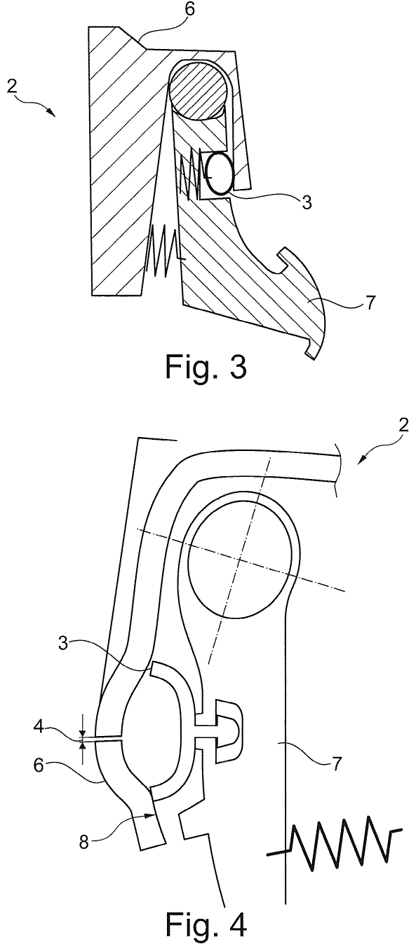

FIGS. 3 through 6 show examples of a pedal. The pedals comprise at least a housing, an operating part, and a damper according to the invention. The damper is arranged between the operating part and the housing. The operating element is movably arranged with respect to the housing, so that the operating element may be brought into a working position from an initial position by an external application of force. An external application of force is usually carried out by a driver of a vehicle, who places his/her foot on the operating part of the pedal and “steps” on it, for example, to initiate a braking action.

FIGS. 3 and 4 show a damper without an additional spring in the interior of the hollow body. In this case, the compression stress or tensile stress of the body during a compression or expansion is sufficient to return the body to its idle position.

In FIGS. 3 through 6, the damper is designed to return the operating part to the initial position from the working position. Upon reaching the initial position, the operating part rests against an end stop. To prevent the operating part from striking hard against the end stop and thereby producing a noise, the valve is designed to control the return of the damper to its idle position. The return of the operating part to the initial position from its working position is also indirectly controlled thereby.

FIG. 5 shows a pedal according to an example of the invention in an initial position, and FIG. 6 shows the same pedal in a working position. FIG. 6 shows that a movement of the operating part relative to the housing induces an expansion of the body. If the operating part is actuated by a driver of the vehicle, for example for a braking, it is important that the damper does not hinder the actuation and present the driver with an unnecessary resistance. For this purpose, the valve of the damper is designed in such a way that, when the operating part of the pedal is actuated so that an expansion of the damper results, the medium, for example air, may very rapidly flow into the body. The actuation of the operating part is thus not hindered and is possible even in the case of a fault in the damper, so as to not impair the traffic safety of the vehicle.

If the process for actuating the operating part has ended, for example the braking, the driver removes his/her foot from the operating part and releases it. The operating part springs back into its initial position. To prevent the operating part from striking the end stop, the valve is designed in such a way that the medium may escape only slowly from the interior of the body. The return of the damper to the idle position, and thus the return of the operating part to the initial position, is thus braked.

The same principle is possible when the damper is compressed during an actuation of the operating part. In this case, the medium flows out rapidly during a compression and is allowed to flow back in only slowly when the operating part is guided back into its initial position.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A damper for a pedal of a vehicle, the damper comprising:
a hollow body to receive a medium, the body being compressible or expandable from an idle position; and
a valve being configured to allow the medium to flow into and/or out of the body, the inflow and/or the outflow of the medium being controlled by the valve such that:
during a compression of the body from the idle position, the outflow of the medium takes place rapidly and, upon the return to the idle position, the inflow of the medium takes place slowly; or
during an expansion of the body from the idle position, the inflow of the medium takes place rapidly and, upon the return to the idle position, the outflow of the medium takes place slowly.

2. The damper according to claim 1, further comprising a spring arranged in an interior of the body, ends of the spring at least indirectly resting against an outer shell of the body in the interior of the body.

3. The damper according to claim 1, wherein the return to the idle position influenced by the valve differs from the return to the idle position, which is influenced by the spring and/or the body.

4. The damper according to claim 1, wherein the spring is compressed during a compression of the body and/or stretched during an expansion of the body.

5. The damper according to claim 1, wherein the body and/or the spring have a compression stress during the compression of the body, wherein the body and/or the spring have a tensile stress during the expansion of the body, and wherein the compression stress counteracts the compression or the tensile stress counteracts the expansion of the body.

6. The damper according to claim 1, wherein the body is at least partially made from an elastomer.

7. The damper according to claim 1, wherein the body comprises multiple parts.

8. The damper according to claim 1, wherein the spring has a linear spring characteristic curve, or a progressive spring characteristic curve, or a digressive spring characteristic curve.

9. A pedal for a vehicle, comprising:
at least a housing;
an operating part; and
the damper according to claim 1,
wherein the damper is arranged between the housing and the operating part.

10. The pedal according to claim 9, wherein the operating part is movably arranged with respect to the housing, the operating part is adapted to be brought into a working position from an initial position by an external application of force.

11. The pedal according to claim 9, wherein a movement of the operating part relative to the housing induces a compression or expansion of the body.

12. The pedal according to claim 9, wherein the damper is designed to move the operating part from the working position into the initial position.

13. The pedal according to claim 9, wherein the operating part rests against an end stop upon reaching the initial position.

14. The pedal according to claim 9, wherein the damper is arranged between the housing and the operating part such that the operating part is in its initial position when the damper reaches the idle position.

15. A system comprising a pedal according to claim 9 and a vehicle.
